(19) United States
(12) Patent Application Publication
(10) Pub. No.: US 2013/0253826 A1
(43) Pub. Date: Sep. 26, 2013

(54) Navigation System and Method

(71) Applicant: Bayerische Motoren Werke Aktiengesellschaft, Muenchen (DE)

(72) Inventor: Marcello TAVA, Muenchen (DE)

(73) Assignee: Bayerische Motoren Werke Aktiengesellschaft, Muenchen (DE)

(21) Appl. No.: 13/896,883

(22) Filed: May 17, 2013

Related U.S. Application Data
(63) Continuation of application No. PCT/EP2011/070474, filed on Nov. 18, 2011.

(30) Foreign Application Priority Data
Nov. 20, 2010 (DE) 10 2010 052 114.0

(51) Int. Cl. G01C 21/34

(52) U.S. Cl. CPC G01C 21/3492
USPC 701/527; 701/533

(57) ABSTRACT

A navigation system includes a memory in which information concerning road sections and information concerning time-dependent traffic restrictions are stored such that time-dependent traffic restrictions are assigned to a portion of the road sections. A route computation process is set up such that, when computing a route, the memory is accessed in order to compute a route based on information concerning road sections and based on information concerning time-dependent traffic restrictions. When computing the route, information concerning time-dependent traffic restrictions for a first portion of the road sections, to which information concerning a time-dependent traffic restriction is assigned, is taken into account and, information concerning time-dependent traffic restrictions for a second portion of the road sections, to which information concerning a time-dependent traffic restriction is assigned, is not taken into account.

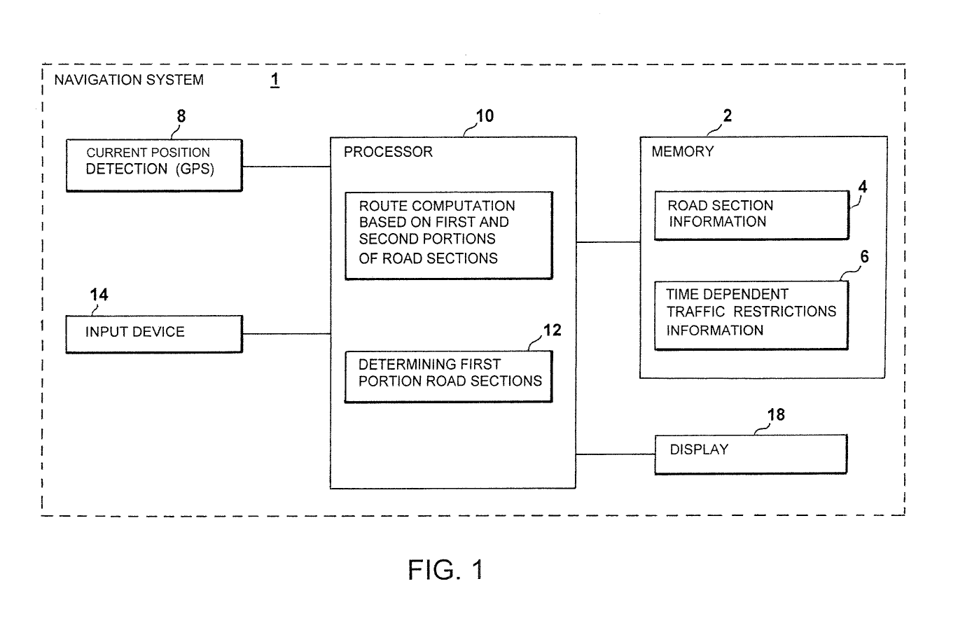

### CROSS REFERENCE TO RELATED APPLICATIONS

This application is a continuation of PCT International Application No. PCT/EP2011/070474, filed Nov. 18, 2011, which claims priority under 35 U.S.C. §119 from German Patent Application No. 10 2010 052 114.0, filed November 20, 2010, the entire disclosures of which are herein expressly incorporated by reference.

### BACKGROUND AND SUMMARY OF THE INVENTION

The invention relates to a navigation system, particularly for a motor vehicle.

By means of navigation systems, it is possible to compute routes between a starting point and a destination point which, based on a digital road map, are optimized according to different criteria.

Such a route is compiled of road sections. In this case, it is suggested to assign information to road sections of the digital road map concerning time-dependent traffic restrictions which correspond to the real traffic restrictions of these road sections.

For example, a time-dependent traffic restriction may consist of the fact that a road section is closed at certain times; that a road section can be traveled only in one direction at certain times; that only certain vehicle types may travel on the road section at certain times; or that a road section may only be traveled at a predefined maximum speed at certain times, etc.

It is an object of the development of modern navigation systems to take into account such time-dependent traffic restrictions when computing routes.

For computing long routes, it was found to be difficult to predict whether or not a time-dependent traffic restriction has to be taken into account for distant road sections. Should, for example, when computing the fastest route from Munich to Hamburg, with a starting time of approximately 3 p.m., a speed restriction for a road section in Hamburg be taken into account that applies to the time period between 10 p.m. and 6 a.m.?

It is an object of the present invention to provide a technical solution to overcome such problems in navigation systems and methods with respect to the state of the art.

This and objects are achieved by a navigation system, and method according to the invention comprising a memory unit (such as a hard disk, a DVD, a remote central card server) in which, for example, as a component of an electronic road map, information concerning road sections and information concerning time-dependent traffic restrictions is stored such that, at least partly, information concerning time-dependent traffic restrictions is assigned to road sections. A route computation device, such as a program-controlled processor, is set up such that, when computing particularly an optimal (fastest, shortest, . . . ) route, the memory unit is accessed in order to compute a route based on the information concerning road sections and the information concerning time-dependent traffic restrictions. When computing the route, information is taken into account concerning time-dependent traffic restrictions for a first portion of the road sections to which a time-dependent traffic restriction is assigned; and for a second portion of the road sections to which a time-dependent traffic restriction is assigned, information is not taken into account concerning time-dependent traffic restrictions.

The time-dependent traffic restrictions preferably are daytime-dependent and/or weekday-dependent traffic restrictions. Continuous-traffic restrictions, for example, time-dependent traffic restrictions caused by long-term construction sites, depending on the embodiment, within the scope of the invention, may or may not be understood to be time-dependent traffic restrictions.

As a result of the invention, it is achieved that, in the case of a route computation (route search or route definition), information concerning time-dependent traffic restrictions is automatically only partially taken into account. For the computation of routes, it therefore becomes possible to take into account the information concerning time-dependent traffic restrictions which, in fact, will have to be taken into account with a particularly high probability. For example, in the case of a remote time-dependent traffic restriction, it is uncertain whether the latter can be applied at all when the concerned vehicle or navigation system arrives at the corresponding road section.

A preferred embodiment of the invention provides that the first portion of the road sections, with respect to the location or time, is closer to the current location of the navigation system or the starting location than the second portion of the road sections, specifically that road sections of the first portion, with respect to the location or time, are closer to the current location of the navigation system or the starting location than road sections of the second portion.

As a result, it is achieved that, for the route computation, a time-dependent traffic restriction will be taken into account only for the road sections which are situated closer to the current location or starting location than other road sections.

For the route computation, only information concerning a time-dependent traffic restriction is therefore taken into account for which a conclusion can be drawn with relatively high reliability as to whether the expected arrival time at the corresponding road section is within or outside the time period to which the traffic restriction can be applied.

For distant road sections, an expected arrival time can be predicted only in a very unreliable manner because, for example, breaks may be taken during the drive to the destination, or stoppages of traffic may occur, or a driver's driving behavior may deviate from an expected driving behavior. Information concerning time-dependent traffic restrictions is preferably not taken into account during a route computation for these distant road sections.

This reduces the expenditures for a route computation or a new route computation and, therefore, the duration for a route computation or new route computation.

In addition, it is thereby prevented that the computed route and therefore the expected arrival time at the destination will change erratically from one new route computation to the other because of distant time-dependent traffic restrictions, depending on which expected arrival times are computed for the distant road sections to which information concerning time-dependent traffic restrictions is assigned. This would considerably irritate a user of a navigation system.

It is a further development of the invention that the second portion of the road sections, with respect to location or time, is closer to the destination location than the first portion of the road sections.

A preferred embodiment provides that the location-related or time-related distance of the road sections of the first portion of road sections from the current location of the navigation system or the starting location is shorter than a predefined limit distance. For example, the road sections whose distance to the current location of the navigation system or the starting location with respect to spatial distance or road distance is shorter than a predefined limit value, such as 300 km, are part of the first portion of road sections.

As an alternative or in addition, the first portion of road sections includes the road sections whose time-related distance from the current location of the navigation system or the starting location is shorter with respect to the expected travel time than a predefined limit value, for example, three hours.

As a result, only those traffic restrictions are included in the route computation for which a relatively reliable conclusion can be drawn as to whether or not they are at all applicable at the expected arrival time at the corresponding road section.

It is a further development of the invention that a taking into account of information concerning time-dependent traffic restrictions comprises a reading of this information concerning time-dependent traffic restrictions from the memory unit.

It is an alternative or additional further development of the invention that a taking into account of information concerning time-dependent traffic restrictions for a road section comprises a determination of an expected arrival time at this road section.

As a result, it only becomes possible at all to decide whether or not a time-dependent traffic restriction is to be taken into account when computing the route. Preferably, a taking into account of information concerning time-dependent traffic restriction for a road section, for this purpose, also comprises a balancing between the expected arrival time at the road section and the time period during which the corresponding traffic restriction can be applied.

A further preferred embodiment provides that a traffic restriction for a road section will (only) be included in the route computation when the corresponding road section is an element of the first portion of road sections (taking into account the information concerning time-dependent traffic restrictions), and when, in addition, the expected arrival time at the road section is within the time period in which the traffic restriction can be applied. Otherwise, a traffic restriction for a road section is preferably not included in the route computation.

A further development finally provides that, when information concerning time-dependent traffic information for a road section is not taken into account, this would mean that the information concerning time-dependent traffic restrictions pertaining to that road section is not even read out of the memory unit and/or the time period, in which the traffic restriction can be applied, is not compared with an expected arrival time.

The expenditures for the route computation can therefore be reduced, and the probably relevant time-dependent traffic restrictions can nevertheless be taken into account for the route computation.

It is an additional further development of the invention that, when information concerning time-dependent traffic restrictions for a road section is not taken into account, this means that no determination of an expected arrival time at this road section is carried out. The expenditures for the route computation can thereby be reduced even further.

Other objects, advantages and novel features of the present invention will become apparent from the following detailed description of one or more preferred embodiments when considered in conjunction with the accompanying drawings.

### BRIEF DESCRIPTION OF THE DRAWING

The figure is a generic block diagram of an on-vehicle navigation system.

### DETAILED DESCRIPTION OF THE DRAWING

In the following, the invention will be explained in detail by means of examples.

The basis is a navigation system that is known per se. Referring to the figure, a navigation system 1 accesses a memory unit 2 by way of an interface, in which memory unit an electronic road map with a plurality of road sections 4 is stored. In addition, information concerning time-dependent traffic restrictions 6 assigned to individual road sections is stored in the memory unit 2. The navigation system further includes an input device 14 through which destination information for the vehicle and the like are input when using the navigation system 1. Further, a display 16 is provided at which a map, a calculated route, and various types of other information are displayable. The display 18 may be integrated with the navigation system 1 or be a separate component coupled to the navigation system.

Information concerning time-dependent traffic restrictions describes, for example, the type of traffic restriction and a time period in which this traffic restriction can be applied or is valid.

In addition, a, for example, current position detecting device 8, such as a GPS-based location determination device, is provided for determining the current location of the navigation system 1.

A route computation processor 10 known per se is constructed for computing a cost-optimized route (fastest, shortest, . . . ), in which case the applicable traffic restrictions can be taken into account. When, for example, a speed restriction or a road closure or lane closure is assigned to a road section for a certain time period, this can be taken into account during a computation of a cost-optimized route (for example, of the fastest route) in that, for example, this road section is not taken into account for a route computation or is linked to a corresponding prolongation of the travel time.

The navigation system is now constructed such that, in the course of a route computation or new route computation, which is automatically carried out from time to time or in the case of certain events, it is first determined which of the road sections (first portion of road sections) 12 is closer to the current location than a limit road distance. During the final route computation, only the information concerning time-dependent traffic restrictions will then be taken into account, in particular, will be read from the memory unit 2, which is assigned to these road sections (first portion of road sections).

Therefore, during the final route computation, only this information concerning time-dependent traffic restrictions will be examined more closely, in particular, will be checked for its applicability. For these road sections (first portion of road sections), an expected arrival time is in each case determined at these road sections and is compared with the time period in which the pertaining traffic restriction can be applied.

When the expected arrival time is within the corresponding applicability period, the pertaining traffic restriction for this road section is taken into account for the final route computation (i.e. the corresponding traffic restriction is included in the route computation or route search), otherwise it is not.

For the computation of the arrival time at a road section, a partial route to the road section is already computed, in which case, possibly already applicable time-dependent traffic restrictions are taken into account which are assigned to a road section of the partial route.

Information concerning time-dependent traffic restrictions of road sections (second portion of road sections) which are farther away from the current location than a limit road distance is either not even read out of the memory unit, pertaining arrival times at the road sections are not even computed, and/or the pertaining applicability time periods are not even compared with pertaining arrival times at these road sections.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A navigation system comprising:
a memory in which information concerning road sections and information concerning time-dependent traffic restrictions are stored such that, in each case, information concerning time-dependent traffic restrictions is assigned to road sections; and
a route computation processor operatively configured such that
when computing a route, the memory is accessed in order to compute the route based on information concerning road sections and based on information concerning time-dependent traffic restrictions, and
when computing the route, information concerning time-dependent traffic restrictions for a first portion of the road sections, to which information concerning a time-dependent traffic restriction is assigned, is taken into account and, information concerning time-dependent traffic restrictions for a second portion of the road sections, to which information concerning a time-dependent traffic restriction is assigned, is not taken into account.

2. The navigation system according to claim 1, wherein:
with respect to location and time, the first portion of the road sections is situated closer to a current location of the navigation system or a starting location than the second portion of the road sections.

3. The navigation system according to claim 1, wherein:
with respect to location and time, the second portion of the road sections is situated closer to a destination location than the first portion of the road sections.

4. The navigation system according to claim 1, wherein:
location-related or time-related distance of the road sections of the first portion of the road sections from a current location of the navigation system or a starting location is shorter than a predefined limit distance.

5. The navigation system according to claim 1, wherein:
a taking-into-account of information concerning time-dependent traffic restrictions for a road section comprises a determination of an expected arrival time at said road section.

6. The navigation system according to claim 1, wherein:
a taking-into-account of information concerning time-dependent traffic restrictions for a road section comprises a balancing between an expected arrival time at said road section and a time period in which the traffic restriction is applicable.

7. The navigation system according to claim 1, wherein:
information concerning time-dependent traffic restrictions for a road section is included in the route computation when the corresponding road section is an element of the first portion of the road sections, and when an expected arrival time at the road section is within a time period in which the traffic restriction is applicable.

8. The navigation system according to claim 1, wherein:
when information concerning time-dependent traffic restrictions for a road section is not taken into account, the information concerning the time-dependent traffic restrictions pertaining to that road section is not read out of the memory unit and/or a time period, in which the traffic restriction is applicable, is not compared with an expected arrival time.

9. The navigation system according to claim 1, wherein:
when information concerning time-dependent traffic restrictions for a road section is not taken into account, no determination of an expected arrival time is carried out at said road section.

10. A method of operating a navigation system having a memory for storing information concerning road sections and information concerning time-dependent traffic restrictions assigned to said road sections, the method comprising the acts of:
accessing the memory when computing a route in order to compute the route based on the information concerning road sections and the information concerning time-dependent traffic restrictions;
taking into account, when computing the route, the information concerning time-dependent traffic restrictions for a first portion of the road sections to which the information concerning time-dependent traffic restrictions is assigned; and
not taking into account, when computing the route, the information concerning the time-dependent traffic restrictions for a second portion of the road sections to which the information concerning the time-dependent traffic restrictions is assigned.

11. The method according to claim 10, wherein:
with respect to location and time, the first portion of the road sections is situated closer to a current location of the navigation system or a starting location than the second portion of the road sections.

12. The method according to claim 10, wherein:
with respect to location and time, the second portion of the road sections is situated closer to a destination location than the first portion of the road sections.

13. The method according to claim 10, wherein:
location-related or time-related distance of the road sections of the first portion of the road sections from a current location of the navigation system or a starting location is shorter than a predefined limit distance.

14. The method according to claim 10, wherein:
a taking-into-account of information concerning time-dependent traffic restrictions for a road section comprises a determination of an expected arrival time at said road section.

15. The method according to claim 10, wherein:
a taking-into-account of information concerning time-dependent traffic restrictions for a road section comprises a balancing between an expected arrival time at said road section and a time period in which the traffic restriction is applicable.

16. The method according to claim 10, wherein:
information concerning time-dependent traffic restrictions for a road section is included in the route computation when the corresponding road section is an element of the first portion of the road sections, and when an expected arrival time at the road section is within a time period in which the traffic restriction is applicable.

17. The method according to claim 10, wherein:
when information concerning time-dependent traffic restrictions for a road section is not taken into account, the information concerning the time-dependent traffic restrictions pertaining to that road section is not read out of the memory unit and/or a time period, in which the traffic restriction is applicable, is not compared with an expected arrival time.

18. The method according to claim 10, wherein:
when information concerning time-dependent traffic restrictions for a road section is not taken into account, no determination of an expected arrival time is carried out at said road section.
